(19) United States
(12) Patent Application Publication
(10) Pub. No.: US 2023/0099420 A1
(43) Pub. Date: Mar. 30, 2023

(54) METHOD AND SYSTEM FOR PRODUCING ADDITIVELY MANUFACTURED OBJECTS

(71) Applicant: PostProcess Technologies, Inc., Buffalo, NY (US)

(72) Inventor: Daniel Joshua Hutchinson, Orchard Park, NY (US)

(73) Assignee: PostProcess Technologies, Inc., Buffalo, NY (US)

(21) Appl. No.: 17/795,326

(22) PCT Filed: Feb. 5, 2021
(86) PCT No.: PCT/US2021/016719

§ 371 Date: Jul. 26, 2022

Related U.S. Application Data
(60) Provisional application No. 62/970,849, filed on Feb. 6, 2020.

(51) Int. Cl. B29C 64/40; B33Y 10/00; B29C 64/379; B33Y 80/00; B33Y 30/00

(52) U.S. Cl. CPC B29C 64/40; B33Y 10/00; B29C 64/379; B33Y 80/00; B33Y 30/00

(57) ABSTRACT

A system and method are disclosed for additively manufacturing an object having an internal chase. The system and method include evaluating a print design file that defines physical properties of the object to be printed with the additive manufacturing process to determine whether the object can be printed with a removable plug located inside the internal chase, and if so, modifying the print design file to include the removable plug. The object is then printed with the removable plug, which is removed prior to removing the support material.

### REFERENCE TO PRIORITY APPLICATION

The present application claims priority to U.S. Provisional Application Ser. 62/970,849, filed Feb. 6, 2020 which is incorporated by reference herein in its entirety and relied upon.

### FIELD OF THE DISCLOSURE

The present disclosure pertains generally to a method and system for making additively manufactured objects.

### BACKGROUND OF THE DISCLOSURE

Additive manufacturing processes, such as 3D printing (e.g., Selective Laser Sintering (SLS), Stereolithography (SLA), fused deposition modeling (FDM), material jetting (MJ), electron beam (e-beam), etc.) provide significant advantages for many applications. Additive manufacturing processes enable the production of parts having complex geometries that would be difficult to make using traditional manufacturing techniques. Also, additive manufacturing processes enable the efficient production of low volumes of parts. However, some additive manufacturing processes produce parts that require removal of unwanted support material. The support material is produced during the printing portion of the additive manufacturing process and is needed to support portions of the part as the part is being printed. After the printing portion of the process is completed, the unwanted support material must be removed before the part can be used for its intended purpose.

A current approach is to manually remove the support material. Removing support material from additively manufactured parts manually can be relatively expensive, inconsistent, and prone to breakage of the part.

As mentioned above, additively manufacturing processes enable the production of parts having complex geometries, including internal chases, passages, cavities or chambers. It is particularly difficult to remove support material from additively manufactured parts having such features. These internal features may be difficult to reach manually or with a detergent spray. Accordingly, there is a need for a method and system for efficiently producing parts with internal passageways using additively manufacturing processes.

### SUMMARY OF THE INVENTION

The invention may be embodied as a system and method for additively manufacturing an object having an internal chase. The system and method include evaluating a print design file that defines physical properties of the object to be printed with the additive manufacturing process to determine whether the object can be printed with a removable plug located inside the internal chase, and if so, modifying the print design file to include the removable plug. The object is then printed with the removable plug, which is removed prior to removing the support material.

### BRIEF DESCRIPTION OF THE DRAWINGS

For a fuller understanding of the nature and objects of the invention, reference should be made to the accompanying drawings and the subsequent description.

FIG. 1 is a perspective view of an additively manufactured part after support material has been removed;

FIG. 2 is a cross sectional view of the additively manufactured part in FIG. 1;

FIG. 3 is the same cross sectional view of the additively manufactured part as shown in FIG. 2 with support material still surrounding the additively manufactured part;

FIG. 4 is a block diagram depicting a system for producing an additively manufactured part according to an embodiment;

FIG. 5 is a block diagram depicting subcomponents of the plug designer component in FIG. 4;

FIG. 6 is a flowchart showing a process for additive manufacturing;

FIG. 7 is a cross sectional view of an additively manufactured part after the printing stage of manufacture according to the embodiment in FIG. 4;

FIG. 8 is the same cross sectional view as shown in FIG. 7 during another stage of manufacture;

FIG. 9 is a cross sectional view of an alternative embodiment of the additively manufactured part shown in FIG. 7;

FIG. 10A shows a cross section of another additively manufactured part that had been manufactured according to a prior art method;

FIG. 10B shows a cross section of the part depicted in FIG. 10A manufactured according to a disclosed embodiment;

FIG. 10C shows a cross section of the part depicted in FIG. 10A manufactured according to another disclosed embodiment;

FIG. 11A shows a cross section of yet another additively manufactured part that had been manufactured according to a prior art method; and

FIG. 11B shows a cross section of the part depicted in FIG. 11A manufactured according to a disclosed embodiment.

### DETAILED DESCRIPTION OF THE INVENTION

At the outset, it should be appreciated that like drawing numbers on different drawing views identify identical, or functionally similar, structural elements of the invention.

Furthermore, it is understood that this invention is not limited to the particular methodology, materials, or modifications described and, as such, the invention may vary from that which is disclosed herein. It is also understood that the terminology used herein is for the purpose of describing particular aspects, and this invention is not limited to the disclosed aspects.

Unless defined otherwise, all technical and scientific terms used herein have the same meaning as commonly understood to one of ordinary skill in the art to which this invention pertains. It should be understood that methods, devices or materials similar or equivalent to those described herein can be used in the practice or testing of the method and system.

Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

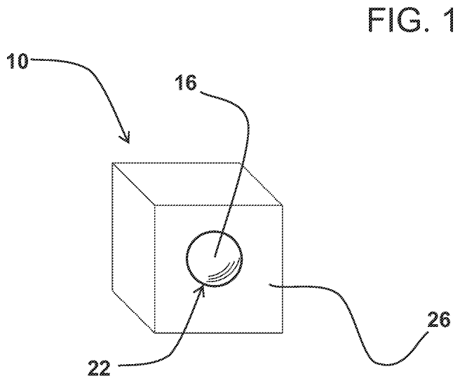

Referring to the figures, FIG. 1 shows an additively manufactured part 10. The additively manufactured part 10 may be produced by different additive manufacturing processes. The additively manufactured part 10 in FIG. 1 is shown after the support material has been removed. As explained above, in many additive manufacturing processes, parts are printed with support material. The support material is needed to support the structure and shape of the part during the printing stage of the additive manufacturing process. After the part is printed, the support material needs to be removed before the part can be used.

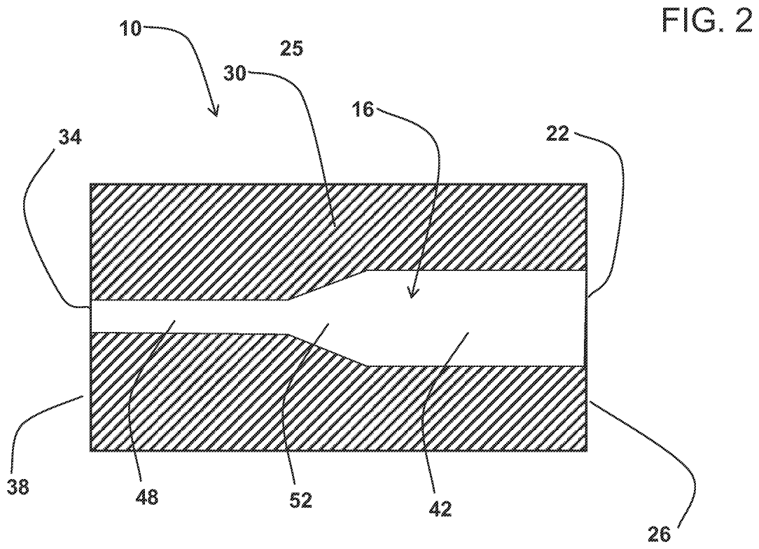

The part 10 includes an internal passage 16 (also referred to herein as a “chase”). As shown in FIG. 2, the internal passage 16 extends through the part 10 from a first opening 22 on one side 26 of the part 10 through a solid interior of a body 30 of the part 10 to a second opening 34 on another side 38 of the part 10. The passage 16 changes dimensions within the body 30 of the part 10. The passage 16 includes a first section 42, a second section 48, and a third section 52. The first section 42 has a first diameter and extends into the body 30 from the first opening 22. The second section 48 has a second diameter, narrower than the first diameter, and extends into the body 30 from the second opening 34. The third section 52 connects the first section 42 and the second section 48 and tapers from the first diameter of the first section 42 to the second diameter of the second section 48.

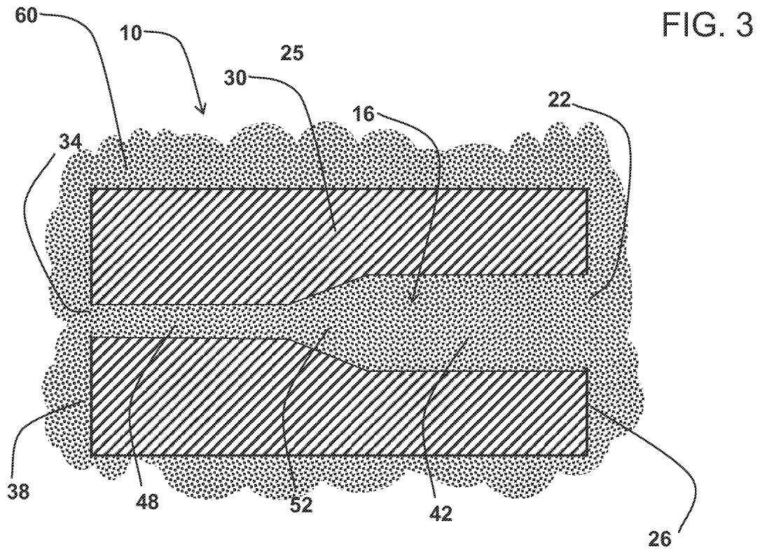

As previously stated, FIGS. 1 and 2 show the additively manufactured part 10 after the support material has been removed. FIG. 3 shows the part 10 after it has been printed but before the support material has been removed. In FIG. 3, the part 10 is shown encased with support material 60. The support material 60 surrounds the exterior of the part 10 and also fills the internal passage 16. The support material 60 needs to be removed before the part 10 can be used.

Suitable systems for removing support material are disclosed in US Pat. Pub. Nos. 20190202126, 20190176403, 20170348910, and 20210008808 and PCT/US20/45068, the entire disclosures of which are incorporated by reference herein. One suitable system for removing the support material is the BASE™ finishing machine available from PostProcess Technologies, Inc. of Buffalo, N.Y. The BASE™ machine removes the support material by applying a spray of a detergent at the part until the support material is removed. Suitable detergents are disclosed in WO 2019/203852 and WO 2020/006141, the entire disclosures of which is incorporated by reference herein. Suitable detergents used in the BASE™ include PLM-101-SPRAY, PLM-102-SPRAY, PLM-201-SPRAY, PLM-202-SPRAY, PLM-401-SPRAY and PLM-501-SPRAY, available from PostProcess Technologies, Inc.

To remove support material from a part that has internal passages, like the part 10 in FIG. 3, a spray can be directed into the internal passage. This is effective for removing support material from additively manufactured parts that have internal passages. However, spraying into the internal passage of an additively manufactured part extends the time needed to remove the support material.

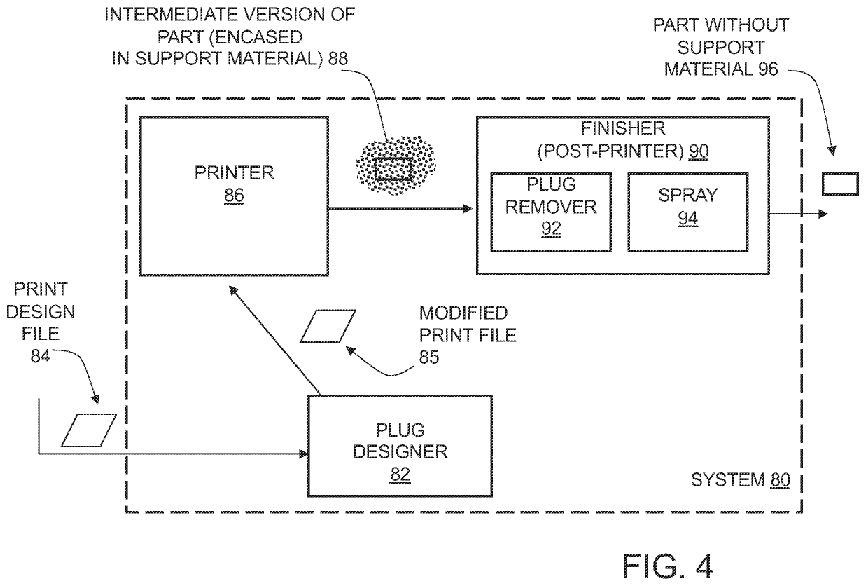

FIG. 4 shows a block diagram of a system 80 for producing additively manufactured parts efficiently according to a first embodiment. The system 80 includes a plug designer component 82, a 3D printer component 86 and a finisher component 90. The plug designer component 82 receives a print design file 84. The print design file 84 may be in any suitable format, such as STL, PLY, or AMF. The plug designer component 82 provides a modified print design file 85 to the 3D printer component 86. The 3D printer component 86 forms an intermediate version 88 of the part according to the modified print design file 84. The intermediate version 88 is encased in support material. The intermediate version 88 is provided to the post-printing finisher component 90. At the post-processing finisher component 90, a plug removal subcomponent 92 removes a plug from the intermediate version 88. Then, the support material is removed from the intermediate version 88 in a spray subcomponent 94. The surface of the part may also be smoothed, if appropriate. The additively manufactured part 96 is completed. The functions performed by the system 80 are explained in more detail as follows.

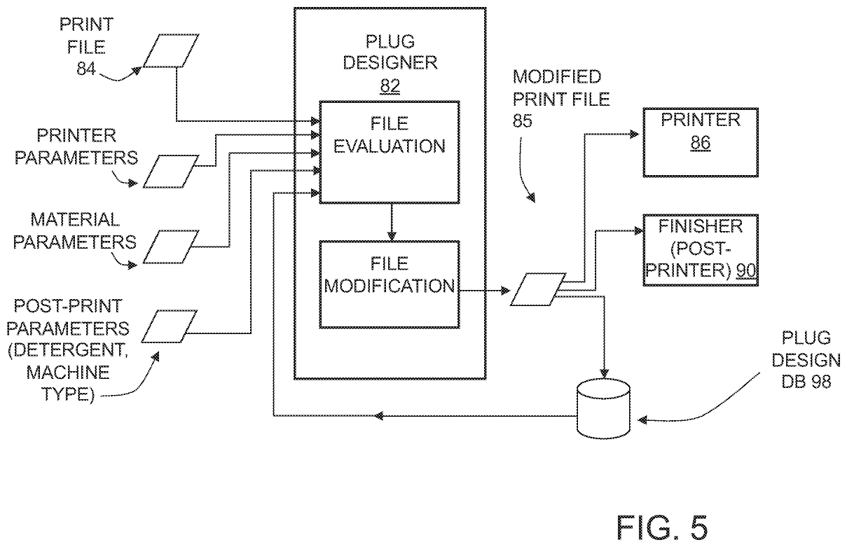

FIG. 5 is a block diagram of the plug designer component 82 shown in FIG. 4. The plug designer component 82 is a software program run on an appropriate computer hardware platform, such as a personal computer, digital controller, etc. The plug designer component 82 receives the original print design file 84. The plug designer component 82 may receive the original print design file 84 from the operator, from the 3D printer component 86 or from another source. The plug designer component 82 may also receive additional data, files, parameters or inputs, including information about the type of 3D printer being used in making the intermediate version of the part, information about the materials used in making the part including information about the material for the body and material for the support material, information about the information about the type of finisher being used for removing the support material, information about the chemicals (e.g., the detergent) being used in the finisher, as well as other information. This additional information may be obtained from an operator, the 3D printer component 86, the finisher component 90, or other sources.

After receiving some or all this information, the plug designer component 82 evaluates whether the part being manufactured has an internal passage and, if so, whether the internal passage is suitable for having a removable plug contained therein. In determining whether an internal passage is suitable for having a removable plug contained therein, the plug designer component takes into account factors such as the size and geometry of the part and the internal passage, the kind of 3D printer being used to make the part, the material from which the part is being printed, the support material being used, the kind of finisher being used, the chemicals used in the finisher for removing support material, as well as other factors. If the plug designer component 82 determines that the internal passage is suitable for having a removable plug, the plug designer component 82 determines the size and geometry of the removable plug, and modifies the original design file to include a removable plug

In one embodiment, the plug designer component 82 also accesses a plug design database 98. The plug design database 98 contains information from previous evaluations of parts with internal passages. The information in the plug design database can be used for facilitating the evaluation of the suitability of modifying a part to include a removable plug. The plug design database 98 may be located locally (e.g., physically proximate with the printer and/or finisher) or remotely (e.g., accessible over a network). The plug design database 98 may be associated with just a single printer and/or finisher or may be shared with multiple printers and/or finishers, either locally or remotely. The information in the plug design database 98 is searchable by part size and geometry, internal passage and geometry, materials, hardware (3D printer, finisher), chemicals (e.g., detergents), etc. After the plug designer component 82 evaluates the suitability of modifying the print design file to include a removable plug, and forms a modified print design file, the information about the evaluation and modified file is stored in the plug design database 98 for use in evaluating print design files in the future.

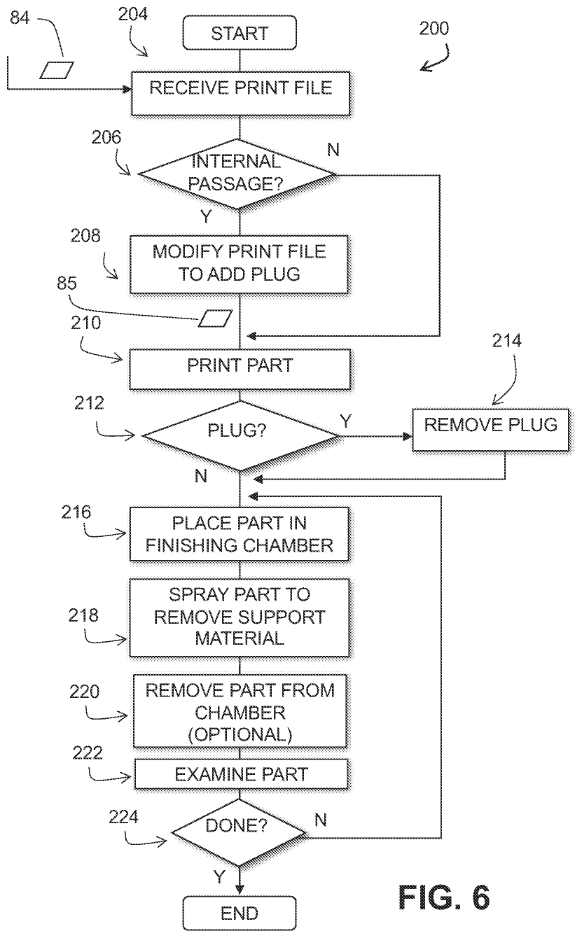

FIG. 6 is a flowchart showing an embodiment of a process 200 for additively manufacturing a part that has an internal passage. The process 200 may be performed by the system 80 in FIG. 4. In a first step (Step 204), the print design file 84 is received. Next, the geometry of the print design file 84 is examined and evaluated to determine whether the part has an internal passage, and if so, whether the geometry of the internal passage is suitable for printing a plug in the internal passage (Step 206). This step may be performed by the plug designer component 82 in FIG. 5. If it is determined that the part does not have an internal passage suitable for printing a plug, the process proceeds to the print stage and the part is printed (Step 210). However, if it is determined that the part has an internal passage suitable for printing a removable plug, the modified print design file 85 is produced (Step 208) and the part is printed using the modified print design file 85 (Step 210). At this stage, the printed part is at the intermediate stage 88 and encased in support material. If the part was printed with the modified print design file 85, the plug is removed (Steps 212 and 214). The step of removing the plug may be done manually or may be done automatically or mechanically as part of the printing process or the finishing process. If the part was printed with the original print design file 84, the plug removal step is omitted (Step 212). Next, the part is placed in a finishing chamber (Step 216). The part is sprayed in the finishing chamber to remove the support material from the part (Step 218). Examples of suitable systems for removing support material from additively manufactured 3D printed parts are the BASE™ and DECI™ support removal machines by PostProcess Technologies, Inc. After the part has been sprayed to remove support material, the part may be removed from the chamber (Step 220). (This step is optional and may be omitted if the next step can be performed without removing the part from the chamber.) The part is examined to determine whether the support material has been removed or whether the part needs more finishing (Step 222). The examining step may be performed by visual observation by an operator or alternatively the examining may be performed by computer controlled scanning. If the part needs more finishing, the part is placed back in the finishing chamber (Steps 224 and 216) and sprayed. If the examination of the part shows that the support material has been removed and no further finishing is required, the process is completed. Information about the entire process, including the finishing time, removable plug, etc., may be stored as described in US Pat. Pub. No. 20190275745, the entire disclosure of which is incorporated by reference herein.

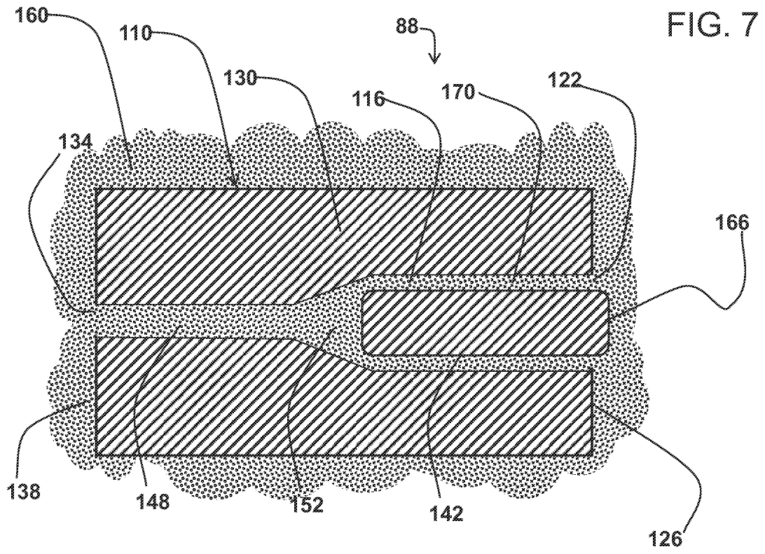

FIG. 7 depicts the additively manufactured part 88 produced according to an embodiment of the disclosed invention. FIG. 7 shows the additively manufactured part at the intermediate stage of manufacture when the part has been printed by the 3D printer but the support material has not yet been removed. The part 88 in FIG. 7 is similar to the part shown in FIG. 3, except that the part 110 in FIG. 7 was printed using the modified print file 85. An original print file, such as the one used to print the part shown in FIG. 3, was modified to include a removable plug in order to print the part shown in FIG. 7.

As shown in FIG. 7, the part 88 includes an internal passage 116 that extends through the part 88 from a first opening 122 on one side 126 through a solid interior of a body 130 to a second opening 134 on the opposite side 138 of the part 88. The passage 116 changes dimensions. The passage 116 includes a first section 142, a second section 148 with a diameter narrower than the first section 142, and a tapering third section 152 connecting the first and second sections 142 and 148.

The part 88 also includes a removable plug member 166. The removable plug member 166 is located inside the internal passage 116. The part 88 is printed with the removable plug member 166 located in the internal passage 116. That is, the removable plug member 166 is printed during the printing process that also prints the part 88. In this embodiment, the removable plug member 166 is composed of the same material as the body 130 of the part 88.

The removable plug member 166 has dimensions that are smaller than the diameter of the internal passage 116. In this embodiment, there is a gap 170 or space between the removable plug member 166 and the inside surface of the passage 116. In the printing process, support material 160 is printed between the removable plug member 166 and the internal passage 116 so that the gap 170 is filled with support material 160 during the printing process. In this embodiment, the removable plug member 166 extends through the first section 142 of the internal passage.

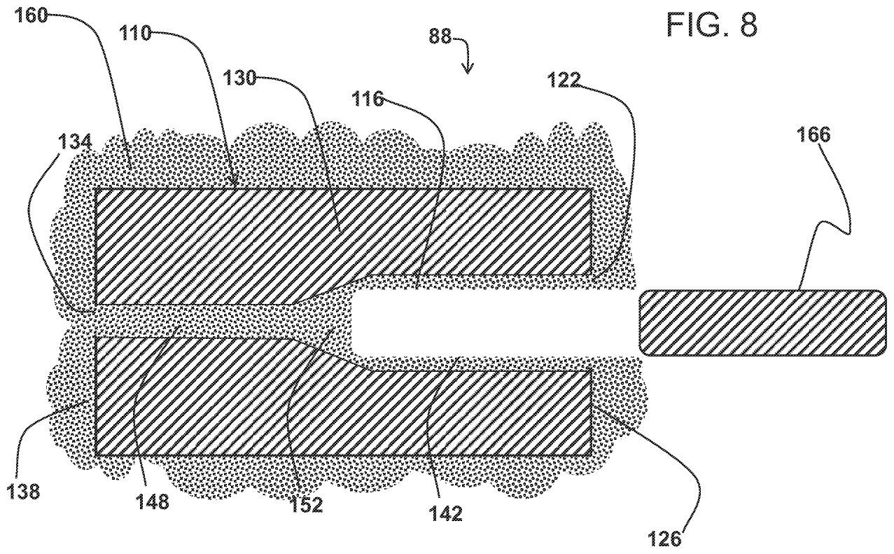

FIG. 8 shows the part 88 at another intermediate stage of the process. In FIG. 8, the removable plug member 166 has been removed from the part 88. (This stage corresponds to Step 214 in FIG. 6 and may be performed by the subcomponent 92 in FIG. 4.) The removable plug member 166 may be removed manually, e.g., by a human operator, or may be removed using an automated process, e.g., a robotic arm. After the removable plug is removed from the part, the removable plug can be recycled or otherwise disposed of

After the removable plug member 166 has been removed, the support material is removed from the part, as described in connection with FIGS. 4 and 5. As shown in FIG. 8, the part 88 contains substantially less support material 160 than the part shown in FIG. 3. Therefore, the support material still remaining on the part 88 in FIG. 8 can be removed much more quickly and efficiently compared to the part 10 shown in FIG. 3. Moreover, as explained above, it can be difficult and time-consuming to remove support material from internal passages of additively manufactured parts. Therefore, the embodiment in FIG. 8 is particularly advantageous because not only does it have less support material than the part shown in FIG. 3, but it has less support material in an internal passage (i.e., passageway 116).

### Alternatives Embodiments

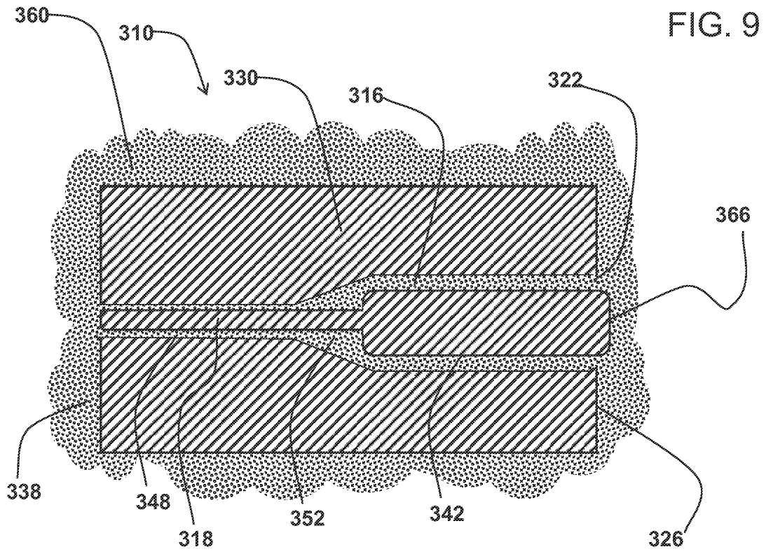

FIG. 9 shows an alternative embodiment of the additively manufactured part after the printing stage. FIG. 9 depicts a part 310 that is similar to the part 88 in FIG. 7. The embodiment in FIG. 9 differs from the part 88 in FIG. 7 in that it is printed with a removable member 366 having a different shape compared to the removable member 116 in FIG. 7. The removable member 316 in FIG. 9 has a narrow portion 318. The narrow portion 318 of the removable member 316 extends into the middle and narrow sections 352 and 348 of the internal passage 316. The embodiment in FIG. 9 is produced in a similar fashion as the embodiment in FIG. 7, i.e., by analyzing the original print design file and determining whether a removable member can be printed to occupy a portion of an internal passage. Like the embodiment in FIG. 7, the removable member 366 is removed before spraying the part to remove the support material. The embodiment shown in FIG. 9 may be even more efficient because the removable member 366 occupies more volume than the embodiment in FIG. 7, and therefore has less support material to remove after the removable member 366 is removed.

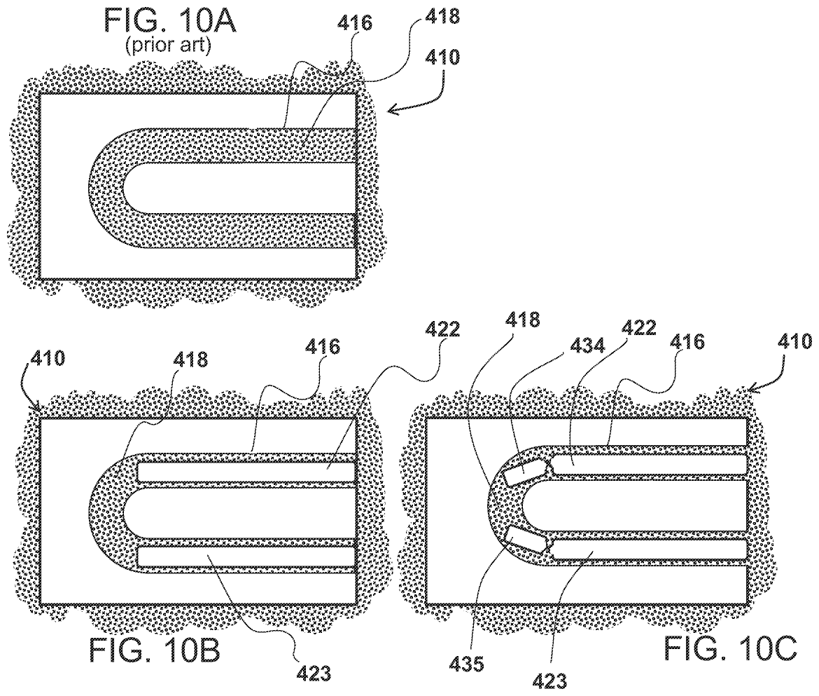

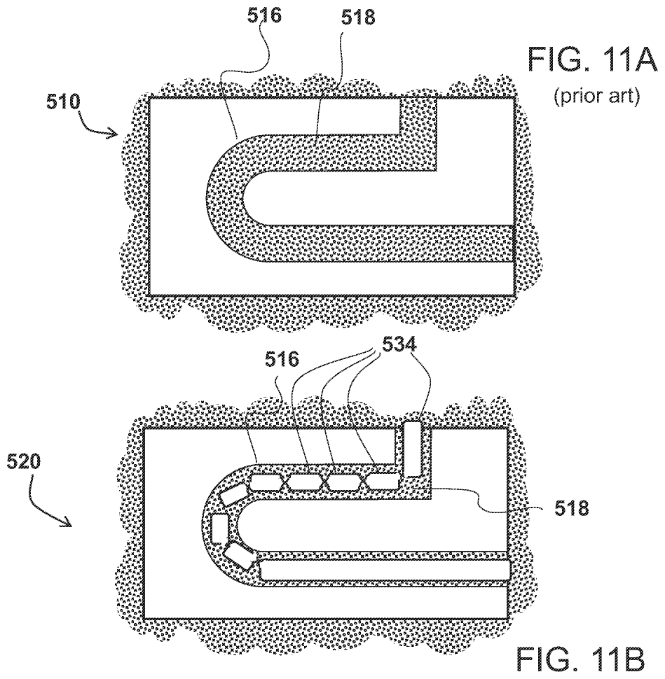

The disclosed system and method enable efficient manufacturing of additively manufactured parts of different shapes, sizes and geometries. As an example, compare FIGS. 10A and 10B. FIG. 10A shows a part 410 with an internal passage 416. The part 410 in FIG. 10A was manufactured by an additive manufacturing process. As illustrated in FIG. 10A, the internal passage 416 is filled with support material 418. The support material 418 was included when printing the part 410 in order to prevent sagging or warping. (For purposes of simplicity, the additively manufactured parts in FIGS. 10A-10C, 11A and 11C are illustrated without cross hatching of the body portions of the parts or the removable plugs.) FIG. 10B shows the part 410 manufactured according to an embodiment of the disclosed invention. In FIG. 10B, the part 410 was printed with removable plugs 422 and 423. The size and shape of the removable plugs 422 and 423 in FIG. 10B were determined by the plug designer component (such as the plug designer 82 in FIG. 5). The removable plugs 422 and 423 occupy a substantial portion of the internal passage 416 of the part 410. The removable plugs 422 and 423 are removed from the part 410 before the support material 418 is removed. Because the embodiment of the part 410 in FIG. 10B contains substantially less support material compared to a part made by prior additive manufacturing processes, removal the support material remaining after the removable plug has been removed can take less time and make the overall process more efficient.

FIG. 10C shows another example. In FIG. 10C, the plug designer component modified the print file of the part 410 to include removable plugs 422 and 423 with extensions 434 and 435. The extensions 422 and 423 are attached to the respective plugs 422 and 423 so that they can be removed together.

FIGS. 11A and 11B depict another example of how the removable plug designer component can make the overall process of manufacturing additively manufactured parts more efficient. FIG. 11A shows an additively manufactured part 510. The additively manufactured part 510 includes an internal passage 516. The internal passage 516 is filled with support material 518. FIG. 11B shows the part 510 manufactured according an embodiment of the removable plug designer component. In FIG. 11C, the removable plug designer component modified an original print file for the part 510 to include a removable plug 534 that occupies space in the internal passage 518. The removable plug 534 is removed before the support material is removed from the part 510.

It was stated above that the step of removing the plug may be done manually or automatically. The removable plug can be removed automatically by means of a mechanical mechanism, such as a robotic arm, clamp, or other means. The mechanical mechanism for removing the plug may be part of the finisher component or may be another separate component. The removable plug may be designed with a hooked or threaded end to facilitate removable either manually or by automatic means.

A system like the one described herein can be used in systems or equipment that finish or otherwise process parts produced by other than additive manufacturing processes. For example, a system like the one described herein can be used in systems or equipment that finish or otherwise process parts produced by traditional manufacturing processes or other kinds of non-traditional manufacturing processes.

In the foregoing description, example embodiments are described. The specification and drawings are accordingly to be regarded in an illustrative rather than a restrictive sense.

It will be appreciated that various aspects of the above-disclosed invention and other features and functions, or alternatives thereof, may be desirably combined into many other different systems or applications. Various presently unforeseen or unanticipated alternatives, modifications, variations, and/or improvements therein may be subsequently made by those skilled in the art, and those alternatives, modifications, variations, and/or improvements are intended to be encompassed by the following claims.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

1. A method of printing an object with an additive manufacturing process comprising:
with the additive manufacturing process, printing a body of the object with body material, wherein the object includes an internal wall defining an internal chase;
with the additive manufacturing process, printing a removable plug located within the internal chase and spaced apart from the wall defining the internal chase; and
with the additive manufacturing process, printing support material between the wall defining the internal chase and the removable plug.

2. The method of claim 1 further comprising:
removing the removable plug from the internal chase of the printed body of the object.

3. The method of claim 2 wherein the removable plug is removed with a mechanical mechanism.

4. The method of claim 2 further comprising:
removing the support material from the wall defining the internal chase.

5. The method of claim 1 wherein the removable plug is composed of the body material.

6. The method of claim 1 wherein the removable plug includes at least one narrow portion.

7. The method of claim 1 wherein the internal chase has sections with different dimensions.

8. An object manufactured according to the method of claim 1.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. The method of claim 1 wherein the additive manufacturing process uses a modified print design file that was prepared by:
evaluating an original print design file that defines physical properties of the object to be printed with the additive manufacturing process to determine whether the object defined by the original print design file includes the internal chase; and
based on the evaluating, preparing the modified print design file that includes the removable plug member in the internal chase.

21. The method of claim 20 wherein the physical properties include at least one of: a size and geometry of the object and the internal chase therein, a material from which the object was printed, and a support material being used.

22. The method of claim 20 further wherein the modified print design file was prepared based on evaluating at least one of: a kind of 3D printer used to make the object, a kind of finisher used to remove the support material, and one or more chemicals used to remove the support material.

23. The method system of claim 20 wherein the step of preparing the modified design file includes determining a size and geometry of the removable plug.

24. The method of claim 20 wherein the additive manufacturing process uses a modified print design file that was prepared by accessing a plug design database that contains information from previous evaluations of objects with internal chases for facilitating evaluation of suitability of modifying the original print file for the object to include a removable plug.

25. The method of claim 1 wherein the removable plug comprises a support material displacement/reduction portion.

26. The method of claim 1 wherein the removable plug is printed with an extension attached thereto so that the removable plug and the extension can be removed together.

27. The method of claim 1 wherein the removable plug is printed with a hooked or threaded end to facilitate removal from the internal chase.

28. The method of claim 1 further comprising:
with the additive manufacturing process, printing multiple removable plugs located within the internal chase and spaced apart from the wall defining the internal chase.

29. A method of producing an object with an internal chase using an additive manufacturing process, comprising:
using a modified design file that defines operation of a printer to produce a body of the object, an internal chase located inside the body of the object, a removable plug member located in the internal chase spaced from walls of the internal chase, and support material located between the walls of the internal chase and the removable plug member; and
printing the object with the printer using the modified design file.

30. A method of printing an object with an additive manufacturing process that reduces an amount of support material used in printing of the object, the method comprising:
with the additive manufacturing process, printing a body of the object with body material, wherein the object includes an internal wall defining an internal chase;
with the additive manufacturing process, printing support material in the internal chase of the body of the object; and
with the additive manufacturing process, printing a removable member located in the support material in the internal chase and spaced apart from the wall defining the internal chase, whereby the amount of support material used in printing of the object is reduced.

31. The method of claim 30 wherein the body of the object and the removable member are composed of a same material.
